(19) United States
(12) Patent Application Publication
(10) Pub. No.: US 2016/0060412 A1
(43) Pub. Date: Mar. 3, 2016

(54) BIODEGRADABLE FOAMED MATERIAL

(71) Applicant: Daniel Bernard Barrette, Belle River (CA)

(72) Inventor: Daniel Bernard Barrette, Belle River (CA)

(21) Appl. No.: 14/476,445

(22) Filed: Sep. 3, 2014

(51) Int. Cl. C08J 9/00; B65D 81/09; B29C 47/78; C08J 9/12; B29C 47/00

(52) U.S. Cl. CPC C08J 9/0061; C08J 9/122; B29C 47/0042; B29C 47/0066; B29C 47/78; B29C 47/0009; B65D 81/09; C08J 2303/04; C08J 2203/06; B29K 2003/00; B29K 2105/04

(57) ABSTRACT

A biodegradable foamed material is formed from corn meal, corn flour and distillers grains, especially dried distillers grains with solubles (DDGS). The foamed material has a low density and is cheaper to produce, has a more pleasing color and may be formed faster and into larger pellets than packaging material formed from corn meal without corn flour and distillers grains. The foamed material is useful in packaging, as insulation and the like.

### FIELD

This application relates to foamed material, particularly to biodegradable foamed material.

### BACKGROUND

Low density foamed material in the form of pellets (e.g. peanuts) is used to provide cushioning for goods packed into boxes and other containers, or to provide insulation. Styrofoam™ is one of the most ubiquitous foamed materials, but large amounts of Styrofoam™ represent an environmental hazard because Styrofoam™ is not easily degraded. As a result, biodegradable foamed materials have been developed, these biodegradable materials generally formed from starches, for example corn meal, corn starch, wheat starch or potato starch.

U.S. Pat. No. 5,476,621 issued Dec. 19, 1995 to Naturpack GmbH discloses a process for producing biodegradable foamed material from starches. The process involves extruding corn grit and subjecting the extruded material to a steaming step to impart elasticity to the product. The cost of this process remains higher than desirable due to the cost of corn grit (i.e. corn meal) and the energy cost in the steaming step.

### SUMMARY

There is provided a biodegradable foamed material formed from corn meal, corn flour and distillers grains.

There is further provided a process for producing biodegradable foamed material, comprising extruding a mixture of corn meal, corn flour and distillers grains in an extruder at a temperature in a range of 125° C. to 165° C. to produce an extruded foamed material.

There is further provided a packaging material comprising a pellet of a biodegradable foamed material formed from corn meal, corn flour and distillers grains.

The use of distillers grains in place of some of the corn meal may reduce the cost of producing the foamed material because distillers grains is significantly cheaper than corn meal. Further, the combination of corn meal, corn flour and distillers grains is significantly easier to extrude thereby reducing energy requirements during extrusion and increasing extrusion rate, thereby further reducing costs. The extrusion rate may be about 1.1 times or more faster, even about 1.2 times or more faster, or even about 1.3 times or more faster, or even about 1.4 times or more faster, than the extrusion rate of a comparable mixture comprising corn meal without corn flour and distillers grains. Such increases in extrusion rate are significant cost savings on a production scale.

Furthermore, because corn meal has a shell that is coarse and firm, the prior art must use a steaming step to break down the corn meal shell. Corn flour, or corn flour and distillers grains, may act as a softening agent thereby eliminating the need for a steaming step to impart elasticity to the product.

In addition, the foamed material produced has a generally more pleasing color (light colored or dark brown) than material made from corn meal alone (yellow), and pellets produced by the process are generally larger while being less dense or of the same density as pellets produced from corn meal without corn flour and distillers grains.

The biodegradable foamed material may be used in a variety of applications including packaging and insulation, preferably packaging.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### DETAILED DESCRIPTION

The biodegradable foamed material is formed from corn meal, corn flour and distillers grains.

Distillers grains are a cereal byproduct of distillation processes, created in distilleries by drying mash. Brewers and ethanol plants are two sources of distillers grains. Wet distillers grains (WDG) contain primarily unfermented grain residues (protein, fiber, fat and up to about 70 wt % moisture). Dried distillers grains with solubles (DDGS) comprise WDG that has been dried to reduce moisture content. The moisture content of DDGS may be less than about 20 wt % based on total weight of the DDGS. The moisture content of DDGS is preferably in a range of about 1-20 wt %, more preferably about 5-18 wt %, yet more preferably about 7-12 wt %, for example about 9 wt %. Dried distillers grains with solubles (DDGS) is preferred. DDGS is more stable than WDG and provides better control over the process. DDGS is preferably used in an amount in a range of about 0.5-50 wt % based on total weight of corn meal, corn flour and DDGS. More preferably, the amount of DDGS is in a range of about 5-50 wt %, yet more preferably about 10-45 wt %, even more preferably about 30-45 wt %. An amount of about 40 wt % is particularly preferred.

Corn meal comprises the outer shell of a kernel of corn, which is a hard and yellow part of the kernel. Corn meal is preferably used in an amount in a range of about 1-99 wt % based on total weight of corn meal, corn flour and DDGS. More preferably, the amount of corn meal is in a range of about 10-90 wt %, yet more preferably about 25-75 wt %, even more preferably about 40-60 wt %. An amount of about 50 wt % is particularly preferred.

Corn flour comprises a mixture of endosperm (corn starch) and corn gluten from a kernel of corn. Corn flour is preferably used in an amount in a range of about 0.5-15 wt % based on total weight of corn meal, corn flour and DDGS. More preferably, the amount of corn flour is in a range of about 7-15 wt %. An amount of about 10 wt % is particularly preferred.

The biodegradable foamed material may have a moisture content greater than zero as a result of moisture in the corn meal, corn flour and/or DDGS, and possibly water and/or other ingredients added during processing. The moisture content of the foamed material may be in a range of about 0.5-10 wt %, or about 1-5 wt %, for example about 2 wt %, based on total weight of the material.

The density of the biodegradable foamed material is preferably in a range of about 0.01-0.1 kg/L, more preferably about 0.015-0.075 kg/L. The density of the biodegradable foamed material may be at least as low as the density of a similar material formed from corn meal without corn flour and distillers grains, and may be even less. The biodegradable foamed material may have a density that is about 1.05 times or more less, even about 1.1 times or more less, than the density of a similar material formed from corn meal without corn flour and distillers grains. A foamed material of lower density is particularly advantages in packaging application to reduce overall weight of containers being shipped.

The biodegradable foamed material may be produced by extruding a mixture of corn meal, corn flour and dried distillers grains with solubles (DDGS) in an extruder at a temperature in a range of about 125° C. to 165° C. to produce an extruded foamed material. The process and apparatus are similar to the process and apparatus disclosed in U.S. Pat. No. 5,476,621 issued Dec. 19, 1995 to Naturpack GmbH, the entire contents of which is herein incorporated by reference. However, in the present disclosure, steam treatment is not required so an after-treatment device employing a steam generator and steam lines is not required. Eliminating the need for steam treatment is a significant energy savings and cost reduction.

The apparatus for performing the process preferably comprises a single screw extruder, although double screw extruders could be adapted to perform the process. The extruder may comprise a cone-shaped barrel in communication with a feed hopper for introducing ingredients into an inlet at a narrow end of the cone-shaped barrel of the extruder. The extruder barrel may gradually widen to an outlet at a wide end of the barrel, and a screw may be disposed within the barrel whereby the screw comprises a truncated conical shape to match the shape of the barrel. The screw may be threadingly mated with at least a portion of an inner surface of the barrel. The screw has a length (L) and a maximum diameter (D). The ratio of D:L is preferably 1:5 or less, for example 1:3. The screw preferably has a rotational rate in a range of about 40-50 rpm during the process.

The apparatus may further comprise a cutting device located outside of the extruder and downstream of the extruder outlet. Extruded foamed material emerging at the outlet may be cut by the cutting device into pellets and then transported or allowed to fall into a collecting hopper or storage bin, or directly into a bag. An after-treatment device and process is not required because the foamed product produced directly from the extrusion process is sufficiently elastic.

In the process, dry corn meal, corn flour and DDGS are preferably pre-mixed prior to introduction into the extruder. Pre-mixing may be performed with any suitable mixer, for example an auger mixer, at ambient temperature for a sufficient length of time to form a relatively well dispersed dry mixture. The amount of time required depends on amount of corn meal, corn flour and DDGS and the mixing rate. If desired, one or more additives may be included in the pre-mixing, preferably in dry form. The one or more additives may include, for example, an insecticide, a microbicide, a colorant and the like. An insecticide is a particularly preferred additive. The amount of additive may be in any suitable range, preferably in a range of about 0.1-1 kg per 150 kg of dry ingredients (corn meal, corn flour and DDGS), for example about 600 grams per 150 kg.

The mixture of corn meal, corn flour and DDGS, along with the one or more additives, may be loaded as a feed mixture into the hopper and fed into a pre-heated extruder through the inlet. The temperature in the extruder is maintained at a temperature in a range of about 125° C. to 165° C., preferably about 140° C. to 155° C., for example about 150° C. The temperature is preferably maintained along the entire length of the extruder. While in the extruder, the mixture undergoes physical and/or chemical transformations due to the heat and the shearing action of the screw. Additionally, as the mixture travels through the ever-widening extruder barrel, the mixture expands and foams so that the material extruded through the outlet of the extruder is a foamed material. The foamed material extruded from the outlet can then be cut into pellets (e.g. peanuts) and the pellets collected.

To assist in the extrusion process, the mixture may be placed in a certain amount of water and charged as a feed mixture from the hopper into the extruder. The corn meal, corn flour and distillers grains are cooked in the water in the barrel of the extruder during the extrusion, the water further helping extrude the material from the extruder. The extruded material looks dry as the material is extruded from the extruder. The amount of water used to assist the extrusion depends at least to some extent on the moisture content of the ingredients used. Where wet distillers grains (WDG) is used, significantly less water would be added to the mixture than in the case where dried distillers grains with solubles (DDGS) is used. WDG has a higher moisture content than DDGS, but is less stable than DDGS. DDGS is generally preferred for its initial stability and because the moisture content of DDGS is generally more easily determined with accuracy, thereby permitting a more accurate determination of an appropriate amount of water to add to the mixture for extrusion. Preferably, the amount of water added may be in a range of about 15-25 liters per 150 kg of dry ingredients (corn meal, corn flour and DDGS), for example about 20 liters per 150 kg of dry ingredients.

To further assist in the foaming process, the feed mixture may comprise a foaming agent, preferably a blowing agent, or one or more agents that can produce a foaming agent under the extrusion conditions. The foaming agent increases foaming of the extruded material. The foaming agent may increase the size of the extruded foamed material by as much as six times or more.

A blowing agent is preferred, the blowing agent being a gas, for example air, nitrogen, oxygen, carbon dioxide, pentane, chlorofluorocarbons and the like. Carbon dioxide is preferred. The blowing agent may be produced by one or more agents that can produce the gas under the extrusion conditions. Preferably, a source of carbon dioxide is added to the mixture to increase foaming of the extruded material. The source of carbon dioxide may comprise a carbonate or bicarbonate together with an acid. The carbonate or bicarbonate preferably comprises a metal carbonate, for example sodium carbonate or calcium carbonate. Calcium carbonate (e.g. limestone) is preferred. The acid is preferably a mineral acid, for example phosphoric acid, hydrochloric acid and the like. Phosphoric acid is preferred. In one embodiment, calcium carbonate in an amount of about 600 grams per 150 kg of dry ingredients (corn meal, corn flour and DDGS) is mixed with the corn meal, corn flour and DDGS to form a dry batch. Technical grade phosphoric acid in an amount of about 1-5 liters (depending on the amount of water to be added) is mixed with water. The dry batch is mixed with the water/acid mixture, fed into the extruder through the hopper and extruded to form the foamed material.

The biodegradable foamed material in accordance with the present disclosure may be extruded with greater ease than a similar foamed material formed from corn meal without corn flour and distillers grains. For example, in the process described above, a mixture comprising corn meal without the presence of corn flour and distillers grains can be extruded to produce pellets at a rate that fills 18 bags per hour, where the bag has a volume of 12 ft³. In contrast, using the same process and bags, a mixture comprising 50 wt % corn meal, 10 wt % corn flour and 40 wt % DDGS can be extruded to produce pellets at a rate that fills 26 bags per hour. This is over 140% faster and represents better extrudability and significant cost savings. In addition, the sizes of the pellets produced using all three of corn meal, corn flour and DDGS were significantly larger.

In one particularly preferred embodiment, a packaging material comprises a pellet of the biodegradable foamed material formed from corn meal, corn flour and distillers grains. Such pellets are larger, less dense and of more appealing color than pellets formed from corn meal without corn flour and distillers grains. The color is light or dark brown as opposed to yellow for the material formed from corn meal without corn flour and distillers grains.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A biodegradable foamed material formed from corn meal, corn flour and distillers grains.

2. The material according to claim 1, wherein the distillers grains comprises dried distillers grains with solubles (DDGS).

3. The material according to claim 2, formed with 25-75 wt % corn meal, 0.5-15 wt % corn flour and 10-45 wt % DDGS, all weights based on total weight of corn meal, corn flour and DDGS.

4. The material according to claim 2, formed with 40-60 wt % corn meal, 7-15 wt % corn flour and 30-45 wt % DDGS, all weights based on total weight of corn meal, corn flour and DDGS.

5. The material according to claim 2, formed with 50 wt % corn meal, 10 wt % corn flour and 40 wt % DDGS, all weights based on total weight of corn meal, corn flour and DDGS.

6. The material according to claim 2 having a density 1.05 times or more less than density of a material formed from corn meal without corn flour and distillers grains.

7. The material according to claim 2 which is a biodegradable foamed pellet.

8. The material according to claim 2 having a moisture content in a range of 1-5 wt % based on weight of the material.

9. A process for producing biodegradable foamed material, comprising extruding a mixture of corn meal, corn flour and distillers grains in an extruder at a temperature in a range of 125° C. to 165° C. to produce an extruded foamed material.

10. The material according to claim 9, wherein the distillers grains comprises dried distillers grains with solubles (DDGS).

11. The process according to claim 10, wherein the mixture comprises 25-75 wt % corn meal, 0.5-15 wt % corn flour and 10-45 wt % DDGS, all weights based on total weight of corn meal, corn flour and DDGS.

12. The process according to claim 10, wherein the DDGS has a moisture content in a range of 1-20 wt %, based on weight of the DDGS.

13. The process according to claim 10, wherein the DDGS has a moisture content in a range of 7-12 wt %, based on weight of the DDGS.

14. The process according to claim 10, further comprising adding water to the mixture.

15. The process according to claim 10, further comprising adding a source of carbon dioxide to the mixture to increase foaming of the extruded material.

16. The process according to claim 15, wherein the source of carbon dioxide comprises a metal carbonate and a mineral acid.

17. The process according to claim 15, wherein the source of carbon dioxide comprises calcium carbonate mixed with phosphoric acid.

18. The process according to claim 10, further comprising cutting the extruded foamed material into pellets.

19. The process according to claim 10, wherein the extruded foamed material is not steamed.

20. The process according to claim 10, wherein the foamed material extrudes at an extrusion rate 1.1 times or more faster than extrusion rate of a mixture comprising corn meal without corn flour and distillers grains.

21. A packaging material comprising a pellet of a biodegradable foamed material formed from corn meal, corn flour and distillers grains.
